(19) United States
(12) Patent Application Publication
(10) Pub. No.: US 2022/0348844 A1
(43) Pub. Date: Nov. 3, 2022

(54) BLENDS OF FUNCTIONALIZED POLY ALKYL GLUCOSIDES FOR LAUNDRY SOIL REMOVAL

(71) Applicant: COLONIAL CHEMICAL, INC., South Pittsburg, TN (US)

(72) Inventors: Robert N. Comber, South Pittsburg, TN (US); Xiangdong Sun, South Pittsburg, TN (US); John W. Baxter, South Pittsburg, TN (US); Robert J. Coots, South Pittsburg, TN (US)

(21) Appl. No.: 17/764,487

(22) PCT Filed: Sep. 28, 2020
(86) PCT No.: PCT/US2020/053150

§ 371 Date: Mar. 28, 2022

Related U.S. Application Data
(60) Provisional application No. 62/906,670, filed on Sep. 26, 2019.

(51) Int. Cl. C11D 1/94; C11D 11/00

(52) U.S. Cl. CPC C11D 1/94; C11D 11/0017; C11D 1/662

(57) ABSTRACT

A laundry or fabric cleaning composition that comprises a surfactant blend that includes a nonionic alkyl polyglucoside, and a functionalized alkyl polyglucoside component.

### FIELD OF THE INVENTION

The present invention relates to the field of surfactants used in laundry detergent compositions, particularly liquid laundry detergents, and in particular the use of blends of functionalized alkyl polyglucosides surfactants. Embodiments of the present invention represent surfactants that are novel for laundry, contain high natural product content, are free of ethoxylation, ethylene oxide, 1,4-dioxane and are biodegradable.

### BACKGROUND AND SUMMARY OF THE INVENTION

Conventional detergents used in the ware washing and laundering industries, particularly those intended for institutional use, generally contain alkyl phenol ethoxylates (APEs). APB are used in detergents as a cleanser and a degreaser for their effectiveness at removing soils containing grease from a variety of surfaces. Commonly used APEs include nonyl phenol ethoxylates (NPE) surfactants.

However, while effective, APEs are disfavored due to environmental concerns. For example, NPEs are formed through the combination of ethylene oxide with nonylphenol (NP). Both NP and NPEs exhibit estrogen-like properties and may contaminate water, vegetation and marine life. NPE is also not readily biodegradable and remains in the environment or food chain for indefinite time periods. Therefore, there was a need in the art for an environmentally friendly and biodegradable alternative that can replace APEs in hard surface cleaners.

This lead to a discovery that environmentally friendly functionalized alkyl polyglucosides surfactants derived from renewable bio-based resources are effective in cleaning, including hard surface cleaning. Specifically, the classes of functionalized alkyl polyglucoside surfactants that were found to be effective for this purpose include: Quaternary functionalized alkyl polyglucosides (U.S. Pat. No. 8,557,760, U.S. Pat. No. 8,389,457, U.S. Pat. No. 8,877,703, and U.S. Pat. No. 10,035,975), Polyquaternary functionalized alkyl polyglucosides (U.S. Pat. No. 8,329,633), Polysulfonate functionalized alkyl polyglucosides (U.S. Pat. No. 8,262,805), Sulfonated alkyl polyglucosides (U.S. Pat. No. 8,071,520 and U.S. Pat. No. 8,216,988), Phosphate functionalized alkyl polyglucosides (U.S. Pat. No. 8,216,994 and U.S. Pat. No. 8,969,285), Poly phosphate functionalized alkyl polyglucosides (U.S. Pat. No. 8,287,659), Sulfosuccinate functionalized alkyl polyglucosides (U.S. Pat. No. 8,658,584), and Betaine functionalized alkyl polyglucosides (U.S. Pat. No. 8,299,009). The underlying functionalized alkyl polyglucosides of these formulations are patented, manufactured, or sold by Colonial Chemical, Inc., South Pittsburg, Tenn. 37380 sold under the Poly Suga® and Suga® trade names.

These functionalized alkyl polyglucosides and blends thereof are now found to be effective as fabric treatment compositions or part of fabric treatment compositions.

In one aspect of the present invention, the surfactant blends of the current invention could be used in spot removal applications such as described in U.S. Pat. No. 6,832,867 “Fabric Treatment Applicator” assigned to the Procter & Gamble Company in which a unique fabric applicator is described for applying spot removal compositions.

In another aspect of the present invention, the surfactant blends of the current invention could be used in conventional liquid laundry compositions such as described in U.S. Pat. No. 5,731,278 “Thickened, Highly Aqueous, Cost Effective Liquid Laundry Compositions” assigned to the Procter & Gamble Company in which low cost, viscous laundry formulations are described.

In another aspect of the present invention, the surfactant blends of the current invention could be used in conventional solid laundry compositions such as described in U.S. Pat. No. 9,951,296 “Solid Free-flowing Particulate Laundry Detergent Composition” assigned to the Procter & Gamble Company in which effective free-flowing solid laundry detergents are described that also effectively deposit perfume.

For example purposes only, the surfactant blends of the current invention could be used in a laundry cleaning wipe such as described in US Patent Application 20160208204 “Three-Phase Heavy-Duty Laundry Detergent Wipe and Method For Manufacturing Same” assigned to Coin Consulting UG in which laundry detergent wipes are described that provide wipes with improved cleaning power.

In another aspect of the present invention, the surfactant blends of the current invention could be used in unit-dose liquid or solid laundry detergent packages such as described in US Patent Application US 20060122088 “Unit Dose Two-Layer Liquid Detergent Packages” assigned to E. S. Sadlowski et al. which describes a unit-dose package for liquid laundry detergent

One of ordinary skill in the art would readily recognize that the surfactant and surfactant blends of the current invention could be used in a host of laundry cleaning applications such as the ones described above, as well as others, including industrial tunnel laundering, high-efficiency laundering, ultra-mild. laundering for babies, collar and sleeve pretreatments, and other specialty laundries like uniforms in sports, military, school, food services in table clothes & napkins, health care, and all types of work.

The compositions of the present invention can be used as stand-alone cleaning agents, used as an enhancer to an existing cleaning/laundering agent, or used as a pre-treatment step prior to laundering with a known agent.

An example of these cleaning formulations of the present invention is a bleach, a surfactant of the present invention or a blend of surfactants of the present invention, a solvent, water, and other optional ingredients. However, the blends of the current invention are appropriate for use in any physical form in laundry applications including a solid such as a powder or granule, a tablet, a solid bar, a paste, gel, or aqueous liquid. They can be used in liquid or powder laundry composition, for both hand and machine wash formulations.

As described herein, one embodiment of the present invention is a laundry or fabric cleaning composition, comprising:
a surfactant blend that includes a nonionic alkyl polyglucoside, and a functionalized alkyl polyglucoside component.

In another embodiment, the composition further comprises water.

In another embodiment, the composition comprises about about 1% to 80% by weight of a nonionic alkyl polyglucoside, and from about 1% to 99% by weight of a functionalized alkyl polyglucoside component. In another embodiment, the composition comprises about 2% to 70% by weight of a nonionic alkyl polyglucoside, and from about 30% to 98% by weight of a functionalized alkyl polyglucoside component. In another embodiment, the composition comprises about 50% by weight of a nonionic alkyl polyglucoside, and about 50% by weight of a functionalized alkyl polyglucoside component.

In another embodiment, the composition comprises a solvent.

In another embodiment, the nonionic alkyl polyglucoside is a sorbitan alkyl polyglucoside crosspolymer.

In another embodiment, the derivatized alkyl polyglucoside is chosen from a carboxymethyl derivatized alkyl polyglucoside, a sulfonate derivatized alkyl polyglucoside, a phosphate derivatized alkyl polyglucoside, a sulfosuccinate derivatized alkyl polyglucoside, a glycinate derivatized alkyl polyglucoside, and a citrate derivatized alkyl polyglucoside.

In another embodiment, the derivatized alkyl polyglucoside is chosen from a polysulfonate derivatized alkyl polyglucoside, polyphosphate derivatized alkyl polyglucoside, polyquaternary derivatized alkyl polyglucoside, polycarboxylated derivatized alkyl polyglucoside, and a polycitrate derivatized alkyl polyglucoside.

In another embodiment, the derivatized polyglucoside surfactant of the present invention comprises a monosaccharide unit, a disaccharide unit, a linker, and a functionalizing agent.

In another embodiment, the surfactant is a sodium laurylglucoside hydroxypropylsulfonate surfactant, a sodium decylglucoside hydroxypropylsulfonate surfactant, or a sorbitan oleate decylglucoside cross polymer.

In yet another embodiment, the derivatized polyglucoside surfactant of the present invention comprises a monosaccharide unit, a disaccharide unit, a crosslinking agent, and a functionalizing agent.

All compositions of the invention can optionally further include at least one of a bleach, surface-active compound, solvent, water conditioning agent, calcium carbonate crystal growth inhibitor, enzyme, polymer, hueing dye, structurant, suds suppressor, preservative, fragrance, antioxidant, fabric softener, and combinations thereof.

Additionally, all compositions of the present invention can be formulated for use in as a spot removal applicator, a saturated towelette, liquid laundry composition, solid (dry) laundry composition, or a unit-dose liquid or solid laundry detergent.

These and other embodiments of the present invention should be obvious based on the description of the invention provided herein.

### Definitions

Unless otherwise indicated, all numbers expressing quantities of ingredients or reaction conditions used herein are to be understood as being modified in all instances by the term “about”.

As used herein, weight percent (wt-%), percent by weight, by weight, and the like are synonyms that refer to the concentration of a substance as the weight of that substance divided by the total weight of the composition and multiplied by 100.

As used herein, the term “about” modifying the quantity of an ingredient in the compositions of the invention or employed in the methods of the invention refers to variation in the numerical quantity that can occur, for example, through typical measuring and liquid handling procedures used for making concentrates or use solutions in the real world; through inadvertent error in these procedures; through differences in the manufacture, source, or purity of the ingredients employed to make the compositions or carry out the methods; and the like. The term about also encompasses amounts that differ due to different equilibrium conditions for a composition resulting from a particular initial mixture. Whether or not modified by the term “about,” the claims include equivalents to the quantities.

The term “alkyl” refers to a straight or branched chain monovalent hydrocarbon radical having a specified number of carbon atoms. Alkyl groups may be unsubstituted or substituted with substituents that do not interfere with the specified function of the composition and may be substituted once or twice with the same or different group. Substituents may include alkoxy, hydroxy, mercapto, amino, alkyl substituted amino, nitro, carboxy, carbonyl, carbanyloxy, cyano, methylsulfonylamino, or halogen, for example. Examples of “alkyl” include, but are not limited to, methyl, ethyl, n-propyl, isoproryl, n-butyl, s-butyl, t-butyl, n-pentyl, n-hexyl, 3-methylpentyl, and the like.

The term “surfactant” or “surface active agent” refers to an organic chemical that when added to a liquid changes the properties of that liquid at a surface.

“Cleaning” means to perform or aid in soil removal, bleaching, microbial population reduction, rinsing, or combination thereof.

As used herein, the term “substantially free” refers to compositions completely lacking the component or having such a small amount of the component that the component does not affect the effectiveness of the composition. The component may be present as an impurity or as a contaminant and shall be less than 0.5 wt. %. In another embodiment, the amount of the component is less than 0.1 wt. % and in yet another embodiment, the amount of component is less than 0.01 wt. %.

It should be noted that, as used in this specification and the appended claims, the singular forms “a,” “an,” and “the” include plural referents unless the content clearly dictates otherwise. Thus, for example, reference to a composition containing “a compound” includes a mixture of two or more compounds. it should also be noted that the term “or” is generally employed in its sense including “and/or” unless the content clearly dictates otherwise.

The term “actives” or “percent actives” or “percent by weight actives” or “actives concentration” are used interchangeably herein and refers to the concentration of those ingredients involved in cleaning expressed as a percentage minus inert ingredients such as water or salts.

As used herein, the terms “alkyl phenol ethoxylate free” or “NPE-free” refers to a composition, mixture, or ingredients that do not contain alkyl phenol ethoxylates or phenol-containing compounds or to which the same has not been added. Should alkyl phenol ethoxylates or -alkyl phenol ethoxylate containing compound be present through contamination of a composition, mixture, or ingredients, the amount of the same shall be less than 0.5 wt. %. another embodiment, the amount of is less than 0.1 wt. % and in yet another embodiment, the amount is less than 0.01 wt. %.

The term “substantially similar cleaning performance” refers generally to achievement by a substitute cleaning product or substitute cleaning system of generally the same degree (or at least not a significantly lesser degree) of cleanliness or with generally the same expenditure (or at least not a significantly lesser expenditure) of effort, or both, when using the substitute cleaning product or substitute cleaning system rather than a alkyl phenol ethoxylate-containing cleaning to address a typical soiling condition on a typical substrate. This degree of cleanliness may, depending on the particular cleaning product and particular substrate, correspond to a general absence of visible soils, or to some lesser degree of cleanliness, as explained in the prior paragraph.

### DESCRIPTION OF EMBODIMENTS OF THE PRESENT INVENTION

Embodiments of the present invention relate to liquid laundry detergent compositions and methods of using the cleaning compositions for laundering fabrics, with the overall goal of performance properties of stain removal and whitening of fabrics. In one embodiment, the cleaning compositions are substantially free of alkyl phenol ethoxylates (APEs) such as nonyl phenol ethoxylates (NPEs). Thus, the cleaning compositions of the present invention provide a green, biodegradable replacement for conventional laundry detergent surfactants and stain removal.

One embodiment of the present invention is to provide a composition useful as a stain remover for fabrics. An example of this embodiment is a liquid composition for a portable stain remover that can be used for pre-laundry application, post-laundry application, or application on fresh stains. As stated above, one embodiment of the present invention is a formulation for use in an applicator for a fabric treatment composition and application thereof. Another embodiment is a saturated towelette. Another embodiment is a liquid, spray, or gel.

These and other objectives, as apparent from the following description, are addressed by the present invention.

The present invention comprises liquid laundry detergent compositions containing unique combinations of environmentally-friendly surfactants derived from renewable bio-based resources. Specifically, it has been discovered that blends (including blends with a ratio of 1:99 to 99:1, and any ratio in between, such as 10:90 to 90:10) of any of the functionalized alkyl polyglucosides in combination with sorbitan oleate decylglucoside crosspolymer (such as Poly Suga®Mulse D9 and Poly Suga®Mulse D6 sold by Colonial Chemical, Inc., South Pittsburg, Tenn. 37380) are effective as liquid laundry detergents. The present inventors discovered that when a sorbitan oleate decylglucoside crosspolymer is combined with the functionalized alkyl glucosides in laundry formulations, the formulations provide performance attributes such as stain removal and whitening.

Thus, one embodiment of the present invention is a cleaning agent that comprises a functionalized alkyl polyglucoside, and a sorbitan oleate decylglucoside crosspolymer.

Examples of the functionalized alkyl polyglucoside of the present invention include, but are not limited to the following: Quaternary functionalized alkyl polyglucosides (U.S. Pat. No. 8,557,760, U.S. Pat. No. 8,389,457, U.S. Pat. No. 8,877,703, and U.S. Pat. No. 10,035,975), Polyquaternary functionalized alkyl polyglucosides (US patent 8,329,633), Polysulfonate functionalized alkyl polyglucosides (U.S. Pat. No. 8,262,805), Sulfonated alkyl polyglucosides (U.S. Pat. No. 8,071,520 and U.S. Pat. No.t 8,216,988), Phosphate functionalized alkyl polyglucosides (U.S. Pat. No. 8,216,994 and U.S. Pat. No. 8,969,285), Poly phosphate functionalized alkyl polyglucosides (U.S. Pat. No. 8,287,659), Sulfosuccinate functionalized alkyl polyglucosides (U.S. Pat. No. 8,658,584), Betaine functionalized alkyl polyglucosides (U.S. Pat. No. 8,299,009), and functionalized alkyl polyglucosides manufactured, and sold by Colonial Chemical, Inc., South Pittsburg, Tenn. 37380 sold under the Poly Suga® and Suga® trade names.

Other examples of the functionalized alkyl polyglucoside of the present invention include, but are not limited to the following: In one embodiment of the present invention, the surfactant is one that is disclosed in U.S. Pat. No. 6,627,612, and/or surfactants sold by Colonial Chemical, Inc. under the brand names Suga®Nate and Suga®Fax.

Another example is those disclosed in U.S. Pat. No. 6,958,315, incorporated herein by reference; and/or surfactants sold by Colonial Chemical, Inc. under the brand name Poly Suga®Glycinate.

Another embodiment of the present invention is a surfactant disclosed in U.S. Pat. No. 8,268,766, incorporated herein by reference; and/or surfactants sold by Colonial Chemical, Inc. under the brand name Poly Suga®Mulse.

Another example is those disclosed in U.S. Pat. No. 7,507,399, and/or surfactants sold by Colonial Chemical, Inc. under the brand names Poly Suga®Quats, Nates, and Phos.

Another example is those disclosed in U.S. Pat. No. 7,087,571, and/or surfactants sold by Colonial Chemical, Inc. under the brand name Poly Suga® Mates.

Another embodiment of the present invention is a surfactant disclosed in U.S. Pat. No. 7,335,627, and/or surfactants sold by Colonial Chemical, Inc. under the brand name Poly Suga® Carb.

Other embodiments of the present invention include surfactants that are sugar-based sulfonate-, phosphate-, glycinate-, sulfosuccinate-, and carboxylate-containing surfactants derived from alkylpolyglucosides, including those disclosed in U.S. Pat. Nos. 6,627,612; 6,958,315; 7,087,571; and 7,335,627.

At least one functionalized alkyl polyglucoside may be used. Thus, in one embodiment, two, three, four, or more functional alkyl polyglucosides may be blended to comprise the functionalized alkyl polyglucoside component of the laundry detergent composition of the present invention.

These derivatized alkyl polyglucosides are naturally derived, do not possess polyoxyethylene groups (or contain residual ethylene oxide monomer or 1,4-dioxane), are biodegradable and in many cases have been found to have very low skin and eye irritation.

In one embodiment the derivatized alkyl polyglucoside is chosen from a carboxymethyl derivatized alkyl polyglucoside, a sulfonate derivatized alkyl polyglucoside, a phosphate derivatized alkyl polyglucoside, a sulfosuccinate derivatized alkyl polyglucoside, a glycinate derivatized alkyl polyglucoside, and a citrate derivatized alkyl polyglucoside.

In another embodiment of the present invention, the derivatized alkyl polyglucoside is chosen from a polysulfonate derivatized alkyl polyglucoside, polyphosphate derivatized alkyl polyglucoside, polyquaternary derivatized alkyl polyglucoside, polycarboxylated derivatized alkyl polyglucoside, and a polycitrate derivatized alkyl polyglucoside.

In one embodiment of the present invention, the derivatized polyglucoside surfactant of the present invention comprises a monosaccharide unit, a disaccharide unit, a linker, including a hydroxypropyl linker, and a functionalizing group.

In this regard, a derivatized alkyl polyglucoside composition of the present invention includes the following, as a mixture:
(a)

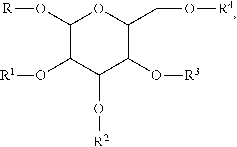

and
(b)

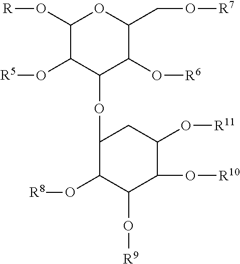

wherein:

R is an alkyl chain having 8 to 22 carbon atoms;

R¹, R², R³, R⁴ R⁵, R⁶, R⁷, R⁸, R⁹, R¹⁰, and R¹¹ are independently selected from the group consisting of: —CH₂—C(O)—O⁻M⁺, or —C(O)CH₂—C(O)—O⁻M⁺

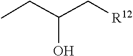

and H, with the proviso that R¹-R¹¹ are not all H;

R¹² is selected from the group consisting of:

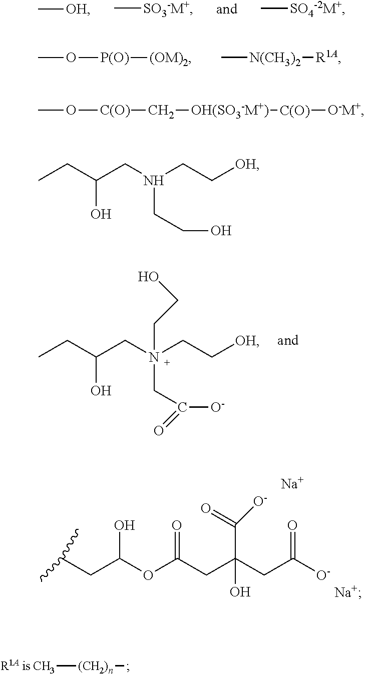

M is a charge balancing group selected from H, Na, K, or NH₄⁺; and
n is an integer from 0-36;
and positional isomers thereof.

In one embodiment of the present invention, the derivatized polyglucoside surfactant of the present invention comprises a monosaccharide unit, a disaccharide unit, a linker, including a hydoxypropyl linker, a crosslinking agent, and a functionalizing group.

In this regard, a derivatized alkyl polyglucoside composition of the present invention includes the following, as a mixture:
(a)

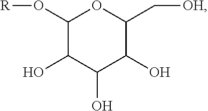

and
(b)

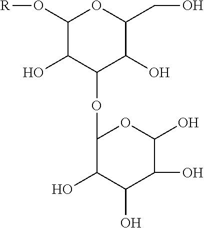

wherein:

R is an alkyl chain having 8 to 22 carbon atoms; a crosslinking agent of the following formula Cl—CH₂—CH(OH)—CH₂—Cl;

and a functionalizing agent selected from:
(i)

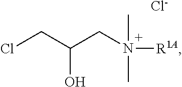

Cl—CH₂—CH(OH)—SO₃M, Cl—CH₂—CH(OH)—SO₄M, Cl—CH₂—CH(OH)—CH₂—OP(O)—(OM)₂, and combinations thereof, wherein R^{1A} is CH₃(CH₂)ₙ-;
(ii) —Cl—CH₂—C(O)⁻Na⁺, 2-halocarboxylic acid, α, β-unsaturated carboxylic acid, cyclic carboxylic acid anhydride, and combinations thereof;
(iii)

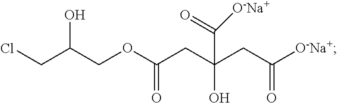

M is a charge balancing group selected from H, Na, K, or NH₄⁺; and

n is an integer from 0-36;

and positional isomers thereof.

Another embodiment of the present invention is a phosphate and/or sulfonate functionalized alkyl polyglucoside of the following compounds, as a mixture, are useful as is as surfactant in laundry applications:
(a)

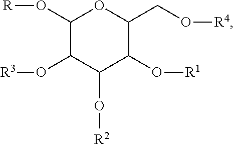

wherein:

R is an alkyl chain having 8 to 22 carbon atoms;

R¹, R², R³, and R⁴ are independently selected from the group consisting of:

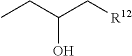

and H, with the proviso that R¹, R², R³, and R⁴ are not all H;

R¹² is selected from the group consisting of: —OH,—SO₃⁻M⁺, —SO₄⁻²M⁺, and —O—P(O)—(OM)₂;

M is selected from the group consisting of Na, K, NH⁴;

and
(b)

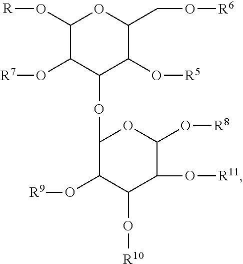

wherein

R⁵, R⁶, R⁷, R⁸, R⁹, R¹⁰, and R¹¹ are independently selected from the group consisting of:

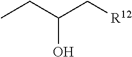

### and H; and

R¹² is selected from the group consisting of: —OH, —O—P(O)—(OM)₂, —SO₃⁻M⁺, and —SO₄⁻²M⁺, and M is selected from the group consisting of Na, K, NH⁴;

and positional isomers thereof.

These alkyl polyglucoside surfactants are manufactured by Colonial Chemical, Inc., South Pittsburg, Tenn. 37380. Two examples of which are sodium laurylglucosides hydroxypropylsulfonate (sold under the brand name Suga®Nate 160NC) and sodium decylglucosides hydroxypropylsulfonate (sold under the brand name Suga®Nate 100NC). The alkylpolyglucoside phosphates of the current invention are manufactured by Colonial Chemical, In., South Pittsburg, Tenn. 37380. An example of which is Sodium Decylglucosides Hydroxypropyl Phosphate, sold under the brand name Suga®Fax D10NC.

These surfactants are synthesized by the methods outlined in U.S. Pat. No. 6,627,612 or their corresponding patents and are generally supplied as clear solutions, 30-50% solids, that may be used as is in laundry applications.

The functionalized alkyl polyglucoside surfactants may also be phosphate functionalized alkyl polyglucosides such as those described in U.S. Pat. No. 8,216,994. Thus, phosphate functionalized alkyl polyglucosides of the present invention include those with the following formula:

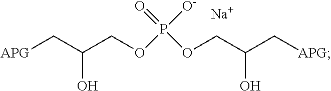

wherein APG is alkyl polyglucoside; and positional isomers thereof. In some embodiments, the alkyl moiety contains about 12 carbon atoms. An example of a suitable phosphate functionalized alkyl polyglucoside includes, but is not limited to, sodium laurylglucosides hydroxypropyl phosphate.

The sulfonated functionalized alkyl polyglucoside surfactants of this embodiment are also described in U.S. Pat. No. 8,216,988. Thus, sulfonated functionalized alkyl polyglucosides of the present invention include those with the following formula:

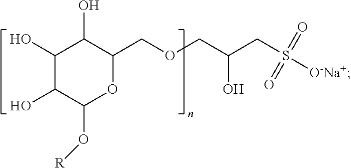

wherein n is between 1 to about 3, and particularly 1.5; and positional isomers thereof. R is an alkyl chain. Examples of suitable sulfonated functionalized alkyl polyglucosides include sodium laurylglucosides hydroxypropyl sulfonate and sodium declyglucosides hydroxypropyl sulfonate and combinations thereof.

Two examples are Sodium Laurylglucosides Hydroxypropylsulfonate (sold under the brand name Suga® Nate 160NC) and Sodium Decylglucosides Hydroxypropylsulfonate (sold under the brand name Suga® Nate 100NC).

An additional embodiment of the present invention is also a glycinate-modified alkylpolyglucoside surfactants represented by compounds of the following formulae, and positional isomers thereof, as a mixture:
(a)

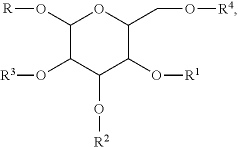

wherein

R is alkyl having 8 to 22 carbon atoms;

R¹, R², R³, and R⁴ are independently selected from

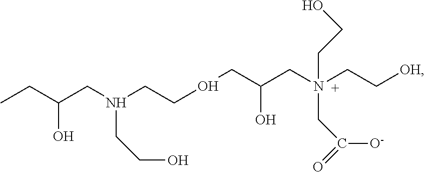

and H, with the proviso that R¹, R², R³, and R⁴ are not all H;
and
(b)

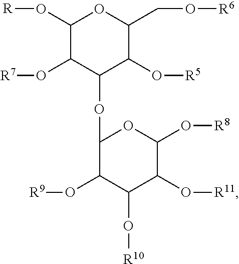

wherein

R is alkyl having 8 to 22 carbon atoms;

R⁵, R⁶, R⁷, R⁸, R⁹, R¹⁰, and R¹¹ are independently selected from

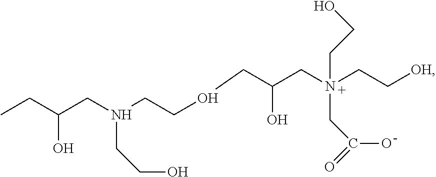

and H, with the proviso that R⁵, R⁶, R⁷, R⁸, R⁹, R¹⁰, and R¹¹ are not all H; and positional isomers thereof.

The alkylpolyglucoside glycinates of the current invention are manufactured by Colonial Chemical, Inc., South Pittsburg, Tenn. 37380, two examples of which are Sodium Bis-Hydroxyethylglycinate Coco-Glucosides Crosspolymer (sold under the brand name Poly Suga® Glycinate C) and Sodium Bis-Hydroxyethylglycinate Lauryl-Glucosides Crosspolymer (sold under the brand name Poly Suga® Glycinate L).

These surfactants are synthesized by the methods outlined in U.S. Pat. No. 6,958,315 and are generally supplied as clear solutions, 30-50% solids, that are used as is in laundry applications.

An embodiment of the present invention is also sulfonate-modified, phosphate-modified and cationically modified poly-sugar alkyl polyglucoside surfactants, represented by compounds of the following formulae, as a mixture:
(a)

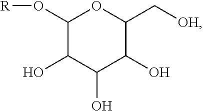

wherein;

R is alkyl having 8 to 22 carbon atoms; and
(b)

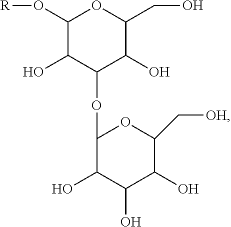

wherein:

R is alkyl having 8 to 22 carbon atoms;

a crosslinker of the following formula: Cl—CH₂—CH(OH)—CH₂—Cl; and

a functionalizing agent selected from:

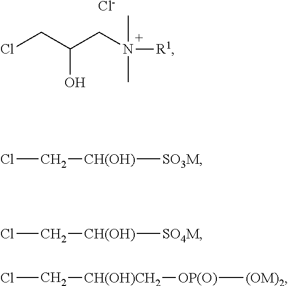

and mixtures thereof

wherein R¹ is CH₃—(CH₂)ₙ—;

n is an integer from 0 to 36;

M is a charge balancing group selected from H, Na, K, or NH₄;

and positional isomers thereof.

These alkyl polyglucosides of the current invention are manufactured by Colonial Chemical, Inc., South Pittsburg, Tenn. 37380, as shown in U.S. Pat. No. 7,507,399. Examples of these alkyl polyglucosides are: sodium hydroxypropyl phosphate decylglucoside crosspolymer (Poly Suga® Phos 1000P), sodium hydroxypropyl phosphate laurylglucoside crosspolymer (PolySuga® Phos 1200P), Sodium hydroxypropyl phosphate cocoglucoside crosspolymer (PolySuga® Phos 8600P), Sodium hydroxypropyl sulfonate butylglucoside crosspolymer (PolySuga® Nate 40P), Sodium hydroxypropyl sulfonate decylglucoside crosspolymer (PolySuga® Nate 100P), Sodium hydroxypropyl sulfonate laurylglucoside crosspolymer (PolySuga® Nate 160P NC), Polyquaternium-78 (Poly Suga® Quat L-1010P), Polyquaternium-80 (Poly Suga® Quat L-1210P) and Polyquaternium-81 (Poly Suga® Quat S-1201P).

Another description of this embodiment is described in U.S. Pat. No. 8,329,633. Thus, poly quaternary functionalized alkyl polyglucosides of the present invention have the following formula:

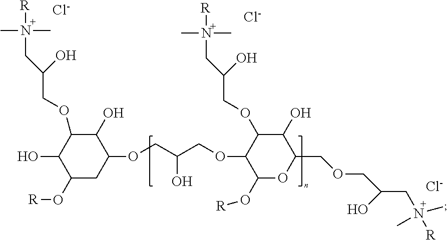

wherein R is an alkyl group having from about 8 to about 22 carbon atoms and n is an integer ranging from 4 to 6; and positional isomers thereof.

Another description of this embodiment is described in U.S. Pat. No. 8,262,805. Thus, poly sulfonate functionalized alkyl polyglucosides of the present invention have the following formula:

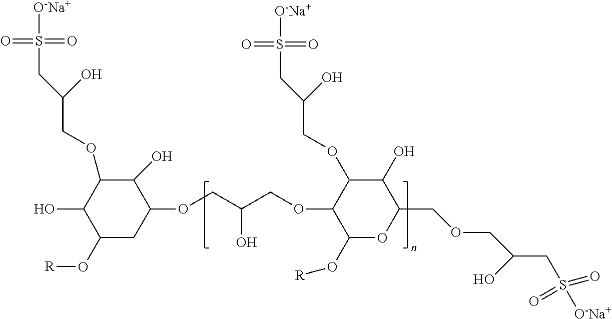

wherein R is an alkyl group having from about 8 to about 22 carbon atoms and n is an integer ranging from 4 to 6; and positional isomers thereof.

Another example of this embodiment is described in U.S. Pat. No. 8,287,659. That is, polyphosphate functionalized alkyl polyglucosides of the following formula:

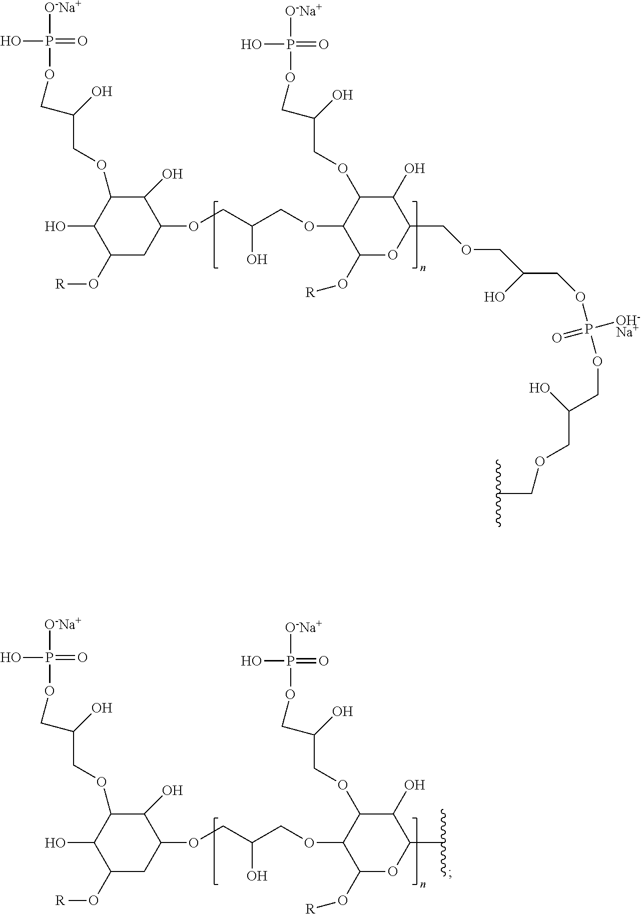

wherein R is an alkyl group having from about 8 to about 22 carbon atoms; and positional isomers thereof.

Another surfactant of the present invention is also described in U.S. Pat. Nos. 8,557,760 and 8,389,457. Quaternary functionalized alkyl polyglucosides of the present invention may have the following representative formula:

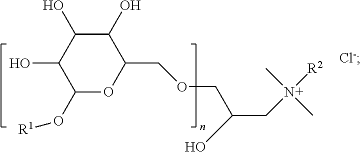

wherein R′ is an alkyl group having from about 8 to about 22 carbon atoms, and R² is CH₃(CH₂)ₙ, and n is independently an integer from 0-21; and positional isomers thereof. Examples of suitable quaternary functionalized alkyl polyglucosides surfactants include those in the R¹ alkyl moiety contains primarily about 12 carbons, the R² group is CH₃.

Embodiments of the present invention are also sulfosuccinate-modified, alkylpolyglucoside surfactants, represented by compounds of the following formulae, as a mixture:
(a)

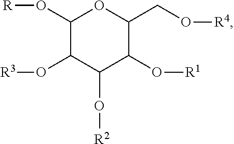

wherein

R is alkyl having 8 to 22 carbon atoms;

R¹, R², R³, and R⁴ are independently selected from —CH₂—CH(OH)—CH₂—R¹², and H, with the proviso that R¹, R², R³, and R⁴ are not all H;

R¹² is —O—C(O)—CH₂—CH(SO₃ M⁺)—C(O)—O⁻M⁺

M is a charge balancing group selected from H, Na, K, or NH₄;

and
(b)

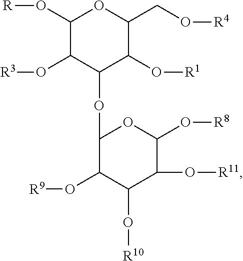

wherein

R is alkyl having 8 to 22 carbon atoms;

R⁵, R⁶, R⁷, R⁸, R⁹, R¹⁰, and R¹¹ are independently selected from —CH₂—CH(OH)—CH₂—R¹², and H,

with the proviso that R⁵, R⁶, R⁷, R⁸, R⁹, R^{10,} and R¹¹ are not all H;

R¹² is —O—C(O)—CH₂—CH(SO₃ M⁺)—C(O)—O⁻M⁺

M is a charge balancing group selected from H, Na, K, or NH⁴;

and positional isomers thereof.

The sulfosuccinate-modified Poly Suga® alkylpolyglucosides (Poly Suga®Mates) of the current invention are manufactured by Colonial Chemical, Inc., South Pittsburg, Tenn. 37380. These surfactants are synthesized by the methods outlined in U.S. Pat. No. 7,087,571 and are generally supplied as clear solutions, 30-50% solids, that are used as is in laundry applications.

Another embodiment of the present invention is carboxymethyl-modified, Poly Suga®-alkylpolyglucoside surfactants, represented by the following components, as a mixture:
(a)

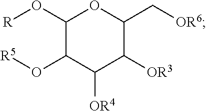

wherein one of R³, R⁴, R⁵, and R⁶ is —CH₂—C(O)—O⁻M⁺ or —C(O)—CH₂—C(O)⁻M⁺, with the remaining R groups being H; R is alkyl having 6 to 30 carbon atoms; M is H, Na, or K; and
(b) a 1,3 dicloloro-2-propanol crosslinker;
   and positional isomers thereof.

The carboxymethyl-modified Poly SugaR alkyl polyglucosides of the current invention are manufactured by Colonial Chemical, Inc., South Pittsburg, Tenn. 37380, examples of which are Sodium Maleate Decylglucoside Crosspolymer (Poly Suga®Carb DM), Sodium Maleate Laurylglucoside Crosspolymer (Poly Suga® Carb LM) and Sodium Succinate Laurylglucoside Crosspolymer (Poly Suga®Carb LS).

These surfactants are synthesized by the methods outlined in U.S. Pat. No. 7,335,627 and are generally supplied as clear solutions, 40-60% solids, that are used as is in in laundry applications.

Another embodiment of the present invention is a citrate-functionalized polymeric alkylglucoside surfactant, represented by the following components, as a mixture:

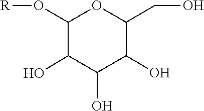

(a)
   and

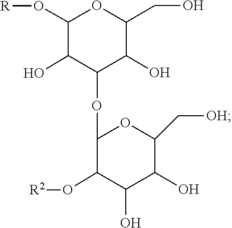

(b)
wherein R is an alkyl having 8 to 22 carbons, and R² is:

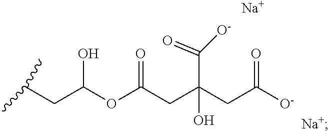

and positional isomers thereof. The citrate-modified Sugax alkyl polyglucosides of the current invention are manufactured by Colonial Chemical, Inc., South Pittsburg, Tenn. 37380, an example of which is Suga®Citrate L1C.

The functionalized alkylpolyglucosides of the present invention have found wide application mostly in the personal care market in various cleansing products such as shampoos, body washes and facial washes. Alone or in blends, they have also found application in surface cleaning, soil removal, as surfactants in emulsion polymerization and in the current invention, laundry applications.

An example of a composition of the present invention is a functionalized alkyl polyglucoside, and nonionic alkyl polyglucoside of the current invention are preferably mixed at about a 50:50 ratio. This mixture may be about 40% to about 95% by weight of the cleaning solution. In other embodiments, the mixture is from about 20:80 to about 80:20, and all amounts in between. That is, the mixture can be 25:75, 30:70, 35:65, 40:60, and so on up to about 80:20.

In embodiments of the invention, this mixture comprises about 40% to about 80% of the cleaning solution.

Laundry detergent compositions according to the present invention can comprise a blend of functionalized alkyl polygluocsides surfactants, and in some instances a bleach. They may also comprise numerous other components as mentioned below. The blends of the current invention are appropriate wherever surfactants are needed in laundry applications including, but not limited to use as surfactants in liquid laundry detergents, solid laundry detergents, liquid and solid unit-dose laundry packages, spot remover applicators, spot remover wipes, and any of a host of other possible laundry applications.

One of ordinary skill in the art would recognize that the laundry formulations of the present invention can include numerous, optional additives to support the cleaning action of the surfactants of the present invention. For example, the formulations can include any combination of the following: bleach, bleach catalyst, dye, hueing agents, cleaning polymers, alkoxylated polyamines, polyethyleneimines, alkoxylated polyethyleneimines, soil release polymers, amphiphilic graft polymers, surfactants, solvents, dye transfer inhibitors, chelants, enzymes, perfumes, encapsulated perfumes, perfume delivery agents, suds suppressor, brighteners, polycarboxylates, structurants, anti-oxidants, deposition aids, preservatives, fabric softeners and mixtures thereof.

To demonstrate further examples the laundry compositions of the invention may additionally contain a surface-active compound which may be chosen from soap and non-soap anionic, cationic, non-ionic, amphoteric and zwitterionic surface-active compounds and mixtures thereof. Many suitable surface-active compounds are available and are fully described in the literature, for example, in “Surface-Active Agents and Detergents”, Volumes I and II, by Schwartz, Perry and Berch.

The laundry compositions of the invention may additionally contain bleaches, that can include peroxide bleaches, most preferably hydrogen peroxide. Other whitening agents can include various per-acids, per-salts, per-bleaches and the like known from the detergency art can be used. Suitable peroxy bleach compounds include organic peroxides such as urea peroxide, and inorganic persalts such as the alkali metal perborates, percarbonates, perphosphates, persilicates and persulphates. Preferred inorganic persalts are sodium perborate monohydrate and tetrahydrate, and sodium percarbonate. The peroxy bleach compound may be used in conjunction with a bleach activator (bleach precursor) to improve bleaching action at low wash temperatures. The preselected pH range of stain removal compositions assists in stabilizing the hydrogen peroxide present and is typically in the acid-slightly basic range from about 3 to about 8, preferably about 6.

The laundry compositions of the invention may additionally contain a solvent and may be selected from alcohols, diols, monoamine derivatives, glycols, or mixtures thereof. Suitable glycols may be selected from polyalkylane glycols, polyalkylene glycols or mixtures thereof. Suitable polyalkyelen glycols include polyethylene glycol. Suitable diols include propane diol, preferably 1,2-propanediol. Monoamine derivatives may comprise monoethanolamine.

The solvent may be selected from the group comprising of polyethylene glycol (PEG) polymer having molecular weight between 300 and 600, dipropylene glycol (DPG), n-butoxy propoxy propanol (nBPP) and mixtures thereof. More preferably the solvent may be selected from the group comprising polyethylene glycol (PEG) polymer having molecular weight between 400 and 600, dipropylene glycol (DPG), nbutoxy propoxy propanol (nBPP) and mixtures thereof. If water is used in a spot remover composition it should preferably be distilled, deionized or otherwise rendered free of residue-forming materials.

The laundry compositions of the invention may additionally contain one or more chelator or water conditioning agents. For example, they may include copper, iron and/or manganese chelating agents. If utilized, chelating agents will generally comprise from about 0.1% by weight of the compositions herein to about 15%, or even from about 3.0% to about 15% by weight of the compositions herein. Suitable chelants may be selected from: diethylene triamine pentaacetate, diethylene triamine penta(methyl phosphonic acid), ethylene diamine-N′N′-disuccinic acid, ethylene diamine tetraacetate, ethylene diamine tetra(methylene phosphonic acid), hydroxyethane di(methylene phosphonic acid), and any combination thereof. A suitable chelant is ethylene diamine-N′N′-disuccinic acid (EDDS) and/or hydroxyethane diphosphonic acid (HEDP). The laundry detergent composition may comprise ethylene diamine-N′N′-disuccinic acid or salt thereof. The ethylene diamine-N′N′-disuccinic acid may be in S,S enantiomeric form. The composition may comprise 4,5-dihydroxy-m-benzenedisulfonic acid disodium salt, glutamic acid-N,N-diacetic acid (GLDA) and/or salts thereof, 2-hydroxypyridine-1-oxide, Triton P.TM. from BASF, Ludwigshafen, Germany. Suitable chelants may also be calcium carbonate crystal growth inhibitors. Suitable calcium carbonate crystal growth inhibitors may be selected from the group consisting of: 1-hydroxyethanediphosphonic acid (HEDP) and salts thereof; N,N-dicarboxymethyl-2-aminopentane-1,5-dioic acid and salts thereof; 2-phosphonobutane-1,2,4-tricarboxylic acid and salts thereof; and any combination thereof.

The composition may comprise a calcium carbonate crystal growth inhibitor, such as one selected from the group consisting of: 1-hydroxyethanediphosphonic acid (HEDP) and salts thereof; N,N-dicarboxymethyl-2-aminopentane-1,5-dioic acid and salts thereof; 2-phosphonobutane-1,2,4-tricarboxylic acid and salts thereof; and any combination thereof.

The laundry compositions of the invention may additionally contain one or more detergent enzymes which provide cleaning performance and/or fabric care benefits. Examples of suitable enzymes include, but are not limited to, hemicellulases, peroxidases, proteases, cellulases, xylanases, lipases, phospholipases, esterases, cutinases, pectinases, keratanases, reductases, oxidases, phenoloxidases, lipoxygenases, ligninases, pullulanases, tannases, pentosanases, malanases, .beta.-glucanases, arabinosidases, hyaluronidase, chondroitinase, laccase, and amylases, or mixtures thereof. A typical combination is a cocktail of conventional applicable enzymes like protease, lipase, cutinase and/or cellulase in conjunction with amylase.

The laundry compositions of the invention may additionally contain polymers include carboxylate polymers, polyethylene glycol polymers, polyester soil release polymers such as terephthalate polymers, amine polymers, cellulosic polymers, dye transfer inhibition polymers, dye lock polymers such as a condensation oligomer produced by condensation of imidazole and epichlorhydrin, optionally in ratio of 1:4:1, hexamethylenediamine derivative polymers, and any combination thereof.

Other polymers include hydroxyethyl cellulose polymer. Preferably, the hydroxyethyl cellulose polymer is derivatised with trimethyl ammonium substituted epoxide. The cellulose polymer may have a molecular weight of between 100,000 and 800,000 daltons. The hydroxyethyl cellulose polymer may be added to the composition as a particle. It may be present in the composition of the particle or may be also be present as a liquid, or a mixture thereof.

The laundry compositions of the invention may additionally contain a hueing dye. The hueing dyes employed in the present laundry care compositions may comprise polymeric or non-polymeric dyes, pigments, or mixtures thereof. Preferably the hueing dye comprises a polymeric dye, comprising a chromophore constituent and a polymeric constituent. The chromophore constituent is characterized in that it absorbs light in the wavelength range of blue, red, violet, purple, or combinations thereof upon exposure to light. In one aspect, the chromophore constituent exhibits an absorbance spectrum maximum from about 520 nanometers to about 640 nanometers in water and/or methanol, and in another aspect, from about 560 nanometers to about 610 nanometers in water and/or methanol.

The laundry compositions of the invention may additionally contain a structurant. Any suitable structurant may be used, however hydrogenated castor oil structurants such as commercially available Thixcin are preferred. The structurant may be selected from non-polymeric or polymeric structurants. The structurant may be a non-polymeric structurant, preferably a crystallisable glyceride. The structurant may be a polymeric structurant, preferably a fibre based polymeric structurant, more preferably a cellulose based fibre-based structurant.

Other polymeric structurants are selected from the group consisting of: hydrophobically-modified ethoxylated urethanes (HEUR); hydrophobically modified alkali swellable emulsion (HASE), and mixtures thereof.

The laundry compositions of the invention may additionally contain a suds suppressor, preferably a siloxane-based polymer suds suppressor (herein also referred to simply as ‘suds suppressor’). The suds suppressor may be an organomodified siloxane polymer. The organomodified siloxane polymers may comprise aryl or alkylaryl substituents optionally combined with silicone resin and/or modified silica. In one embodiment, the suds suppressor is selected from organomodified silicone polymers with aryl or alkylaryl substituents combined with silicone resin and optionally a primary filler. Particularly preferred are silicone suds suppressor compounds consisting of organomodified silicone polymers with aryl or alkyaryl substituents combined with silicone resin and modified silica as described in U.S. Pat. Nos. 6,521,586; 6,521,587; US Applications 2005/0239908; 2007/01673; and 2008/0021152 to Wacker Chemie AG.

The laundry compositions of the invention may additionally comprise preservatives for storage using conventional preservatives such as KATHON® and others commonly used in surfactant applications.

The laundry composition of the inventions may additionally comprise an anti-static agent. If an antistatic benefit is desired, compositions can contain an anti-static agent. Examples of anti-stats include the series of sulfonated polymers available as VERSAFLEX 157, 207, 1001, 2004 and 7000, from National Starch and Chemical Company.

The compositions of the present invention may also include traditional fragrances, perfumes, and odor absorbing components, such as cyclodextrins.

The laundry compositions of the invention may additionally contain an anti-oxidant. The antioxidant is preferably selected from the group consisting of butylated hydroxyl toluene (BHT), butylated hydroxyl anisole (BHA), trimethoxy benzoic acid (TMBA), alpha, beta, lamda and delta tocophenol (vitamin E acetate), 6 hydroxy-2,5,7,8-tetra-methylchroman-2-carboxylic acid (trolox), 1,2, benzisothiazoline-3-one (proxel GLX), tannic acid, galic acid, Tinoguard AO-6, Tinoguard TS, ascorbic acid, alkylated phenol, ethoxyquine 2,2,4 trimethyl, 1-2-dihydroquinoline, 2,6 di or tert or butyl hydroquinone, tert, butyl, hydroxyl anisole, lignosulphonic acid and salts thereof, benzofuran, benzopyran, tocopherol sorbate, butylated hydroxyl benzoic acid and salts thereof, galic acid and its alkyl esters, uric acid, salts thereof and alkyl esters, sorbic acid and salts thereof, dihydroxy fumaric acid and salts thereof, and mixtures thereof. Preferred antioxidants, when used, are those selected from the group consisting of alkali and alkali earth metal sulfites and hydrosulfites, more preferably sodium sulfite or hydrosulfite.

Additionally, any conventional fabric conditioning agent may be used in the compositions of the present invention. The conditioning agents may be cationic or non-ionic. If the fabric conditioning compound is to be employed in a main wash detergent composition the compound will typically be non-ionic. If used in the rinse phase, they will typically be cationic. Preferred cationic fabric softening agents comprise a substantially water insoluble quaternary ammonium material comprising a single alkyl or alkenyl long chain having an average chain length greater than or equal to C₂₀ or, more preferably, a compound comprising a polar head group and two alkyl or alkenyl chains having an average chain length greater than or equal to C₁₄.

### Methods/Experimental

The following is presented for exemplary purposes only. It is not intended to be construed as limiting the present invention.

In order to demonstrate the cleaning power of the liquid laundry surfactant blends of the current invention, the following materials and processes were used. Pre-stained fabrics were purchased from Testfabrics, Inc. (415 Delaware Avenue, West Pittston, Pa. 18643)(see http://www.cftbv.n1/wp-content/uploads/2019/12/CFT-Pricelist-2020.pdf for descriptions). Specifically, sheets of MON-ASTM-01 were purchased containing 22 test fabrics, pre-stained according to ASTM D4265. Three types of studies were conducted on these fabrics: 1) mixtures of functionalized alkyl polyglucosides surfactants were compared to NPE as laundry pre-treatments (at 20% active) before washing in Tide; 2) washing test fabrics in 25% active blends of functionalized alkyl polyglucosides surfactants and comparing to Tide at 25%; and 3) using a fully formulated spot removal formula containing functionalized alkyl polyglucosides surfactants before washing with commercial Tide laundry detergent. Changes in the color of stained test fabrics in all studies were measured using a HunterLab MiniScan EZ 4000S colorimeter and Delta L, a, b, values are the changes compared to the untreated test fabrics.

### Functionalized Alkyl Polyglucosides Surfactants as Laundry Pre-Treatments

For initial studies we chose fabric CS-155, or Bill (Blue) Berry Juice to conduct stain removal and laundry cleaning experiments using the functionalized alkyl polyglucosides surfactants as pre-treatments. The test formulations (20% actives) used for initial pre-treatment are seen in Table 1. All are blends of either a quaternary-, sulfonate- or phosphate-functionalized alkyl polyglucoside with a nonionic functionalized alkyl polyglucoside (surfactant active levels appear in parentheses next to surfactant names in Table 1). They were compared to NPE as pre-treatments on test fabrics before washing in Tide.

TABLE 1
Blends of Functionalized Alkyl Polyglucosides
as pretreatments

| | Solu- | Solu- | Solu- | Solu- | Solu- | |
|---|---|---|---|---|---|---|
| | tion | tion | tion | tion | tion | |
| | 1 | 2 | 3 | 4 | 5 | NPE |
| Water | q.s. to | q.s. to | q.s. to | q.s. to | q.s. to | q.s. to |
| | 100% | 100% | 100% | 100% | 100% | 100% |
| PolySuga ®Quat | 10% | | | | | |
| L1210P (30%) | | | | | | |
| Suga ®Nate 160NC | | 10% | | | | |
| PolySuga ®Nate | | | | 10% | | |
| 160P(40%) | | | | | | |
| SugaFax D10NC | | | 10% | | | |
| (40%) | | | | | | |
| SugaCitrate L1C | | | | | 10% | |
| (40%) | | | | | | |
| Poly Suga ®Mulse | 10% | 10% | 10% | 10% | 10% | |
| D9 (66%) | | | | | | |
| Nonylphenol | | | | | | 20% |
| Ethoxylate (NPE) | | | | | | |
| TOTAL | 100% | 100% | 100% | 100% | 100% | 100% |

In these studies, test fabrics approximately 330 mg in weight were treated with approximately 115 mg of test solution. Test fabrics were dampened with the test solution, allowed to sit 15 minutes at room temperature and then washed in Tide (400 to 1 dilution in water; 6.7 gal.). A 0.9 cu. ft. portable Magic Chef washing machine (model MCSTCW09W1) was used with a 41 minute wash and rinse cycle (12 minute wash, 2 rinses 12 mins each, 5 min final spin). Fabrics were removed at the end of the rinse cycle and allowed to air dry overnight. They were then read with a HunterLab Colorimeter using the “Physical” method program comparing L,a,b values of all fabrics to the original values of fabric CS-155, or Bill (Blue) Berry Juice (L,a,b values for CS-155 are L:50.24; a: 24.35; b: -5.44). Five readings were taken of each test fabric and the averages are reported in Table 2.

TABLE 2

| | Colorimeter measurements of fabrics pretreated with | | | | | | | |
|---|---|---|---|---|---|---|---|---|
| | blends of functionalized alkyl polyglucosides | | | | | | | |
| | | | | Solution | Solution | Solution | Solution | Solution |
| | | Tide | NPE | 1 | 2 | 3 | 4 | 5 |
| CS-155 | Δ L | 25.55 | 27.81 | 26.22 | 25.92 | 26.66 | 27.5 | 26.30 |
| Blueberry | | | | | | | | |
| | Δ a | −26.51 | −21.50 | −21.26 | −21.47 | −21.27 | −21.53 | −21.49 |
| | Δ b | 0.38 | 3.13 | 3.21 | 3.21 | 2.32 | 2.73 | 2.34 |

The results in Table 2 clearly document the cleaning power of blends of functionalized alkyl polyglucosides in combination with a leading commercial laundry detergent. It is clear that all of the polyglucosides are at least providing some synergy with the commercial detergent and equivalency to NPE. To demonstrate the effectiveness of the functionalized alkyl polyglucosides alone, we next washed stained test fabrics using 25% solutions of the functionalized alkyl polyglucosides, comparing to Tide at approximately 25% active (determined by a solids measurement on Tide).

### Functionalized Alkyl Polyglucosides Surfactants as Laundry Detergents

Functionalize alkyl polyglucoside blends (25% active) were then used as the primary laundry detergent and compared to Tide. Prestained swatches were attached to a piece of white fabric with safety pins. Swatch stains selected were mustard (CS-67) (L,a,b values for CS-67: L, 88.99; a, -3.70; b, 46.81), liquid make-up (CS-17) (L,a,b values for CS-17: L, 69.61; a, 41.15; b, 6.75), and sebum (CS-94) (L,a,b values for CS-94: L, 80.22; a, 1.31; b, 10.27). The polyglucoside test solutions were 25% active and diluted 400:1 (total volume: 6.7 gal) for the wash cycle. Swatches were placed in a washing machine with test solution and washed with a cold water wash cycle totaling 41 minutes. Once wash was completed fabrics were then left out to dry at room temp overnight. After drying they were then read with a HunterLab Colorimeter using the “Physical” method program comparing L,a,b values of all fabrics to the original values of fabric. The results are shown in Table 3.

TABLE 3
Functionalized Alkyl Polyglucoside blends as laundry detergents

| | | | | Solution | Solution | Solution | Solution | Solution |
|---|---|---|---|---|---|---|---|---|
| | | Tide | NP-9 | 1 | 2 | 3 | 4 | 5 |
| Mustard | Δ L | 1.17 | −0.01 | −1.61 | 0.25 | −0.25 | 0.06 | −0.61 |
| | Δ a | 2.92 | 3.49 | 3.85 | 2.97 | 2.68 | 3.39 | 3.41 |
| | Δ b | −28.56 | −26.01 | −19.62 | −27.43 | −21.03 | −23.24 | −21.08 |
| Makeup | Δ L | 12.61 | 11.03 | 7.76 | 10.85 | 12.17 | 0.91 | 9.66 |
| | Δ a | −20.98 | −19.05 | −14.22 | −19.04 | −20.96 | −15.82 | −16.98 |
| | Δ b | −8.42 | −4.89 | −3.41 | −4.63 | −5.04 | −4.2 | −4.4 |
| Sebum | Δ L | 7.65 | 7.44 | 2.93 | 8.63 | 2.94 | 7.01 | 4.85 |
| | Δ a | −0.39 | −1.22 | −1.05 | −1.31 | −1.02 | −1.15 | −1.09 |
| | Δ b | −9.77 | −6.16 | −4.51 | −7.3 | −4.97 | −5.91 | −5.39 |

The data in Table 3 demonstrate that all of the blends of the functionalized polyglucosides have significant cleaning properties and some rival the cleaning of Tide, a fully formulated laundry detergent. No attempt was made by the inventors to optimize the cleaning potential of the blends through the addition of solvents, chelates, enzymes, bleaching agents, or any other typical laundry ingredient. In some noteworthy results, Solution 3, a blend of nonionic and phosphate functionalized alkyl polyglucosides rivaled the cleaning of Tide on makeup stains. Blends containing Sulfonate (Solution 2) and citrate (Solution 5) functionalized alkyl polyglucosides were also effective against makeup. All were blends of nonionic and anionically functionalized polyglucosides. Similarly, some of the glucoside blends (2 and 4) were almost effective as Tide against both sebum and mustard stained fabrics.

### Functionalized Alkyl Polyglucosides in Fully-Formulated Spot Remover Formulations:

Solution 3, a blend of nonionic and phosphate functionalized alkyl polyglucosides, was evaluated against Tide-To-Go (Procter & Gamble) for spot removal performance. Solution 3 was included in the spot removal formula in Table 4, patterned after a similar formula in U.S. Pat. No. 6,832,867 “Fabric Treatment Applicator” assigned to the Procter & Gamble company.

TABLE 4
Spot remover formulation similar to those disclosed in
U.S. Pat. No. 6,832,867 “Fabric Treatment Applicator” assigned to
the Procter & Gamble Company

| Component | Weight % |
|---|---|
| Butoxy Propoxy Propanol (BPP) | 2 |
| Hydrogen Peroxide, 30% | 6.7 |
| Solution 3, 20% | 3.5 |
| Ethanol | 0.7 |
| EDTA | 0.005 |
| Water | 87.095 |
| Total | 100 |

In the spot removal experiments, approximately 110 mg of the formula in Table 4 (H₂O₂ was added to the formula just prior to use) was applied to roughly 330 mg of test fabrics (CS-96, Grape Juice; CH-016, Grass; CH-035, Dry Ink and CS-115 Blue Berry Juice). In a similar fashion, liquid from expressing a Tide-To-Go applicator was also applied at approximately the same ratio (110 mg solution to 330 mg fabric). After sitting for 15 minutes at room temperature, the test fabrics were placed in a washing machine and washed in Tide (400 to 1 dilution in water; 6.7 gal) with a cold water wash cycle totaling 41 minutes. Once the wash was completed fabrics were then left out to dry at room temp overnight. After drying they were then read with a HunterLab Colorimeter using the “Physical” method program comparing L,a,b values of all fabrics to their original values (CS-96, Grape Juice: L, 67.24; a, 9.48; b, 2.35. CH-016, Grass: L, 71.08; a, −0.92; b, 22.15. CH-035, Dry Ink: L, 52.72; a, 11.21; b, −50.17)

TABLE 5

| | Blends of Functionalized Alkyl | | | |
|---|---|---|---|---|
| | Polyglucosides in Spot Removers | | | |
| | | Tide | Tide-To-Go | Colonial-To-Go |
| Grape Juice | ΔL | 21.13 | 22.32 | 22.12 |
| (CS-96) | Δa | −8.04 | −8.32 | −8.34 |
| | Δb | −4.84 | −4.3 | −4.43 |
| Grass | ΔL | 13.91 | 14.13 | 15.30 |
| (CH-016) | Δa | 1.1 | 1.42 | 1.2 |
| | Δb | −13.28 | −15.19 | −15.8 |
| Ink | ΔL | 11.59 | 13.69 | 14.07 |
| (CH-035) | Δa | −10.44 | −10.18 | −10.11 |
| | Δb | 11.36 | 13.19 | 12.89 |
| Blueberry | ΔL | | 30.77 | 32.06 |
| Juice | Δa | | −22.29 | −22.13 |
| (CS-155) | Δb | | 3.93 | 5.44 |

Inspection of the values in Table 5 shows that Solution 3, when incorporated into a fully formulated spot removal formula, provided spot removal performance equivalent to formulations described in U.S. Pat. No. 6,832,867 “Fabric Treatment Applicator”. Solution 3, a mix a phosphate functionalized alkyl polyglucoside and a nonionic functionalized alkyl polyglucoside, demonstrated cleaning potential over a range of stain types.

Inspection of the “L” values in Tables 3 and 5 demonstrate the whitening power of the blends of the current invention. The results above demonstrate their versatility as laundry surfactants and cleaning power that could be used in commercial applications.

As mentioned above, the blends of the present invention are unique, are biodegradable and have an advantage of being comprised only of naturally-derived surfactants that are free of ethylene oxide or dioxane, and are free of any nonylphenol ethoxylates.

The invention thus being described, it would be obvious that the same can be varied in many ways. Such variations that would be obvious to one of ordinary skill in the art is to be considered as being bard of this disclosure.

Unless otherwise indicated, all numbers expressing quantities of ingredients, properties such as reaction conditions, and so forth used in the Specification are to be understood as being modified in all instances by the term “about.” Accordingly, unless indicated by the contrary, the numerical parameters set forth in the Specification and Claims are approximations that may vary depending upon the desired properties sought to be determined by the present invention.

Notwithstanding that the numerical ranges and parameters setting forth the broad scope of the invention are approximations, the numerical values set forth in the experimental sections or the example sections are reported as precisely as possible. Any numerical value, however, inherently contain certain errors necessarily resulting from the standard deviation found in their respective testing measurements.

All patents, published patent applications, and other publications references herein are incorporated by reference in their entirety.

1. A laundry or fabric cleaning composition, comprising:
a surfactant blend that includes a nonionic alkyl polyglucoside, and a functionalized alkyl polyglucoside component.

2. The composition of claim 1, further comprising water.

3. The composition of claim 1, comprising about 1% to 80% by weight of a nonionic alkyl polyglucoside, and from about 1% to 99% by weight of a functionalized alkyl polyglucoside component.

4. The composition of claim 1, comprising about 2% to 70% by weight of a nonionic alkyl polyglucoside, and from about 30% to 98% by weight of a functionalized alkyl polyglucoside component.

5. The composition of claim 1, comprising about 50% by weight of a nonionic alkyl polyglucoside, and about 50% by weight of a functionalized alkyl polyglucoside component.

6. The composition of claim 1, further comprising a solvent.

7. The composition of claim 1, wherein the nonionic alkyl polyglucoside is a sorbitan alkyl polyglucoside crosspolymer.

8. The composition of claim 1, wherein the derivatized alkyl polyglucoside is chosen from a carboxymethyl derivatized alkyl polyglucoside, a sulfonate derivatized alkyl polyglucoside, a phosphate derivatized alkyl polyglucoside, a sulfosuccinate derivatized alkyl polyglucoside, a glycinate derivatized alkyl polyglucoside, and a citrate derivatized alkyl polyglucoside.

9. The composition of claim 1, wherein the derivatized alkyl polyglucoside is chosen from a polysulfonate derivatized alkyl polyglucoside, polyphosphate derivatized alkyl polyglucoside, polyquaternary derivatized alkyl polyglucoside, polycarboxylated derivatized alkyl polyglucoside, and a polycitrate derivatized alkyl polyglucoside.

10. The composition of claim 1, wherein the derivatized polyglucoside surfactant of the present invention comprises a monosaccharide unit, a disaccharide unit, a linker, and a functionalizing agent.

11. The composition of claim 1, wherein the surfactant is a sodium laurylglucoside hydroxypropylsulfonate surfactant, a sodium decylglucoside hydroxypropylsulfonate surfactant, or a sorbitan oleate decylglucoside cross polymer.

12. The composition of claim 1, wherein the derivatized polyglucoside surfactant of the present invention comprises a monosaccharide unit, a disaccharide unit, a crosslinking agent, and a functionalizing agent.

13. The composition of claim 1, wherein the derivatized alkyl polyglucoside surfactant is a composition that includes the following, as a mixture:
(a) 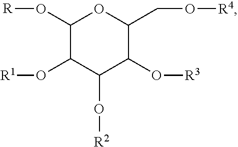
and
(b) 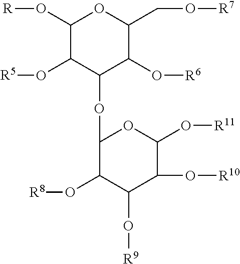
wherein:
R is an alkyl chain having 8 to 22 carbon atoms;
R¹, R², R³, R⁴ R⁵, R⁶, R⁷, R⁸, R⁹, R¹⁰, and R¹¹ are independently selected from the group consisting of: —CH₂—C(O)—O⁻M⁺, or —C(O)CH₂—C(O)—O⁻M⁺ 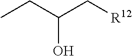
and H, with the proviso that R¹-R¹¹ are not all H;
R¹² is selected from the group consisting of: 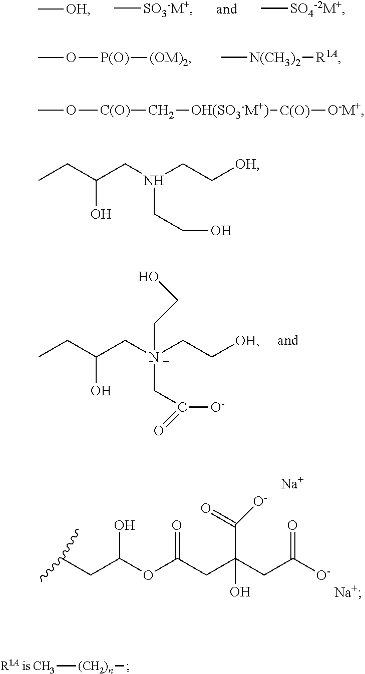
M is a charge balancing group selected from H, Na, K, or NH₄⁺; and
n is an integer from 0-36;
and positional isomers thereof.

14. The composition of claim 1, wherein the derivatized alkyl polyglucoside surfactant is a composition that includes the following, as a mixture:
(a) 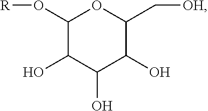
and
(b) 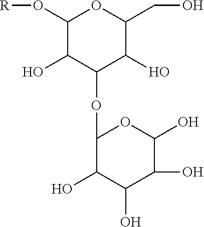
wherein:
R is an alkyl chain having 8 to 22 carbon atoms;
a crosslinking agent of the following formula Cl—CH₂—CH(OH)—CH₂—Cl; and
a functionalizing agent selected from:
(i) 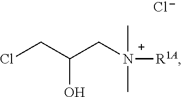
Cl—CH₂—CH(OH)—SO₃M, Cl—CH₂—CH(OH)-SO₄M, Cl—CH₂—CH(OH)—CH₂-OP(O)—(OM)₂, and combinations thereof, wherein
R^{1A} is CH₃(CH₂)ₙ-;
(ii) —Cl—CH₂—C(O)—O-⁻Na⁺, 2-halocarboxylic acid, α, β-unsaturated carboxylic acid, cyclic carboxylic acid anhydride, and combinations thereof;
(iii) 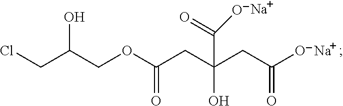 [SMILES: [Na+] ; O=C([O-])CC(O)(CC(=O)OCC(O)CCl)C(=O)[O-] ; [Na+] ; ";"]
M is a charge balancing group selected from H, Na, K, or NH₄⁺; and
n is an integer from 0-36;
and positional isomers thereof.

15. The composition of claim 1, wherein the functionalized alkyl polyglucoside surfactant is a composition that includes the following, as a mixture:
(a) 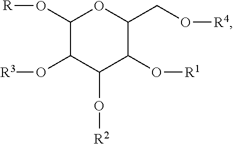
wherein:
R is an alkyl chain having 8 to 22 carbon atoms;
R¹, R², R³, and R⁴ are independently selected from the group consisting of: 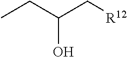
and H, with the proviso that R¹, R², R³, and R⁴ are not all H;
R¹² is selected from the group consisting of:
—OH, —SO₃⁻M⁺, —SO₄⁻²M⁺, and —O—P(O)—)—(OM)₂;
M is selected from the group consisting of Na, K, NH⁴;
and
(b) 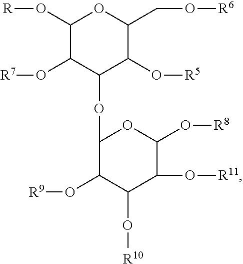
wherein
R⁶, R⁷, R⁸, R⁹, R¹⁰, and R¹¹ are independently selected from the group consisting of: 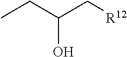
and H; and
R¹² is selected from the group consisting of:
—OH, —O—P(O)—(OM)₂, —SO₃⁻N⁺, and —SO₄⁻²M⁺, and M is selected from the group consisting of Na, K, NH⁴;
and positional isomers thereof.

16. The composition of claim 1, wherein the functionalized alkyl polyglucoside surfactant is a composition that includes the following compound: 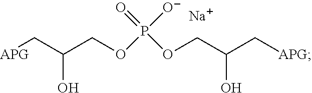
wherein APG is alkyl polyglucoside; and positional isomers thereof.

17. The composition of claim 1, wherein the functionalized alkyl polyglucoside surfactant is a composition that includes the following compound: 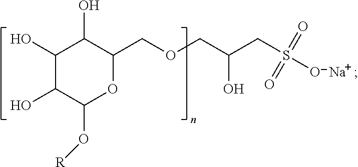
wherein n is between 1 to about 3,
R is an alkyl chain;
and positional isomers thereof.

18. The composition of claim 1, wherein the functionalized alkyl polyglucoside surfactant is a composition that includes the following, as a mixture:
(a) 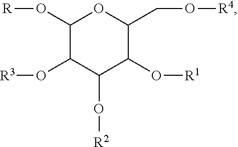
wherein
R is alkyl having 8 to 22 carbon atoms;
R¹, R², R³, and R⁴ are independently selected from 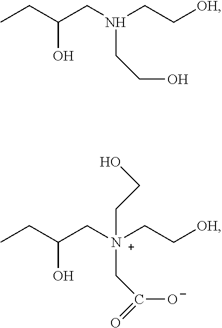 [SMILES: CCC(O)CN(CCO)CCO ; CCC(O)C[N+](CCO)(CCO)CC(=O)[O-]]
and H, with the proviso that R¹, R², R³, and R⁴ are not all H;
and
(b) 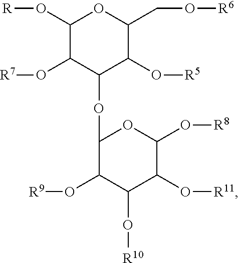
wherein
R is alkyl having 8 to 22 carbon atoms;
R⁵, R⁶, R⁷, R⁸, R⁹, R¹⁰, and R¹¹ are independently selected from 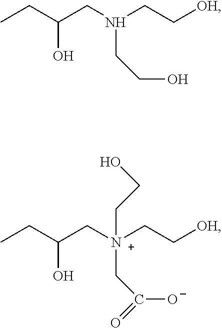 [SMILES: CCC(O)CN(CCO)CCO ; CCC(O)C[N+](CCO)(CCO)CC(=O)[O-]]
and H, with
the proviso that R⁵, R⁶, R⁷, R⁸, R⁹, R^{10,} and R¹¹ are not all H;
and positional isomers thereof.

19. The composition of claim 1, wherein the functionalized alkyl polyglucoside surfactant is a composition that includes the following, as a mixture:
(a) 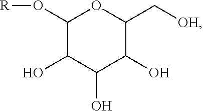
wherein;
R is alkyl having 8 to 22 carbon atoms; and
(b) 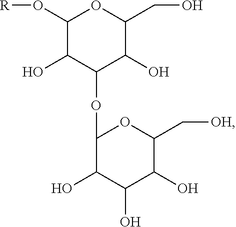
wherein:
R is alkyl having 8 to 22 carbon atoms; and
(c) a sorbitan ester of the following structure: 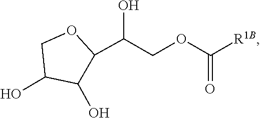
wherein:
R^{1B} is alkyl having 7 to 21 carbons;
a crosslinking agent of the following structure: 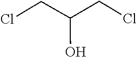
in water; and optionally
a functionalizing agent selected from the group of: 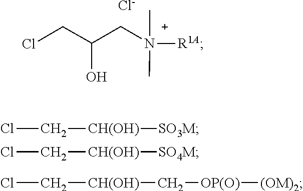
and mixtures thereof;
wherein R^{1A} is CH₃—(CH₂)ₙ-;
n is an integer from 0 to 36;
M is a charge balancing group selected from H, Na, K, or NH₄;
and positional isomers thereof.

20. The composition of claim 1, wherein the functionalized alkyl polyglucoside surfactant is a composition that includes the following, as a mixture:
(a) 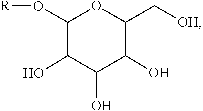
wherein;
R is alkyl having 8 to 22 carbon atoms; and
(b) 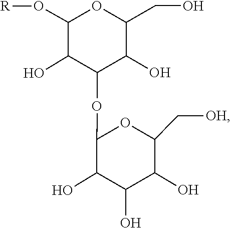
wherein:
R is alkyl having 8 to 22 carbon atoms;
a crosslinker of the following formula: Cl—CH_{2—}CH(OH)—CH₂—Cl; and
a functionalizing agent selected from: 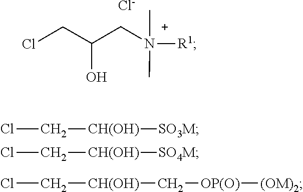
and mixtures thereof;
wherein R¹ is CH₃—(CH₂)ₙ-;
n is an integer from 0 to 36;
M is a charge balancing group selected from H, Na, K, or NH₄;
and positional isomers thereof.

21. The composition of claim 1, wherein the functionalized alkyl polyglucoside surfactant is a composition that includes the following, as a mixture:
(a) 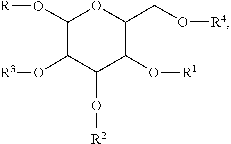
wherein
R is alkyl having 8 to 22 carbon atoms;
R¹, R², R³, and R⁴ are independently selected from —CH₂—CH(OH)—CH₂—R¹, and H, with the proviso that R¹, R², R³, and R⁴ are not all H;
R¹² is —O—C(O)—CH₂—CH(SO₃M⁺)—C(O)-O⁻M⁻
M is a charge balancing group selected from H, Na, K, or NH₄.
and
(b) 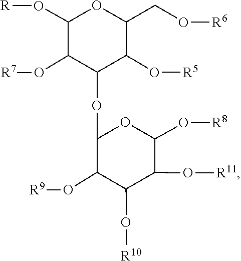
wherein
R is alkyl having 8 to 22 carbon atoms;
R⁵, R⁶, R⁷, R⁸, R⁹, R¹⁰ , and R¹¹ are independently selected from —CH_{2—}CH(OH)—CH₂—R¹², and H,
with the proviso that R⁵, R⁶, R⁷, R⁸, R⁹, R¹⁰, and R¹¹ are not all H;
R¹² is —O—C(O)—CH₂—CH(SO₃ M⁺)—C(O)—O⁻M⁺
M is a charge balancing group selected from H, Na, K, or NH₄;
and positional isomers thereof.

22. The composition of claim 1, wherein the functionalized alkyl polyglucoside surfactant is a composition that includes the following, as a mixture:
(a) 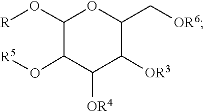
wherein one of R³, R⁴, R⁵, and R⁶ is —CH₂—C(O)—O⁻M⁺or —C(O)—CH₂—C(O)—O⁻M⁺, with the remaining R groups being H; R is alkyl having 6 to 30 carbon atoms; M is H, Na, or K; and
(b) a 1,3 dicloloro-2-propanol crosslinker;
and positional isomers thereof.

23. The composition of claim 1, wherein the functionalized alkyl polyglucoside surfactant is a composition that includes the following, as a mixture: 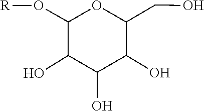
(a)
and 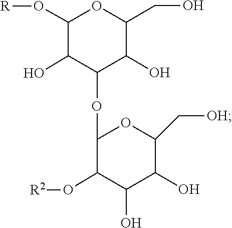
(b)
wherein R is an alkyl having 8 to 22 carbons, and R² is: 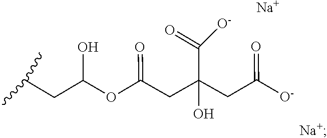
and positional isomers thereof.

24. The composition of claim 1, further comprising at least one of a bleach, surface-active compound, solvent, water conditioning agent, calcium carbonate crystal growth inhibitor, enzyme, polymer, hueing dye, structurant, suds suppressor, preservative, fragrance, antioxidant, fabric softener, and combinations thereof.

25. The composition of claim 1, formulated for use in as a spot removal applicator, a saturated towelette, liquid laundry composition, solid laundry composition, or a unit-dose liquid or solid laundry detergent.
